(19) United States
(12) Patent Application Publication
(10) Pub. No.: US 2025/0158010 A1
(43) Pub. Date: May 15, 2025

(54) APPARATUS FOR MANUFACTURING SECONDARY BATTERY AND METHOD FOR MANUFACTURING SECONDARY BATTERY USING THE SAME

(71) Applicant: LG ENERGY SOLUTION, LTD., Seoul (KR)

(72) Inventors: Jun Gyu HEO, Daejeon (KR); Suk KIM, Daejeon (KR)

(73) Assignee: LG ENERGY SOLUTION, LTD., Seoul (KR)

(21) Appl. No.: 18/838,480

(22) PCT Filed: Feb. 15, 2023
(86) PCT No.: PCT/KR2023/002211

§ 371 Date: Aug. 14, 2024

(30) Foreign Application Priority Data
Feb. 15, 2022 (KR) 10-2022-0019794

(51) Int. Cl. H01M 4/04

(52) U.S. Cl. CPC H01M 4/0404

(57) ABSTRACT

An apparatus for manufacturing a secondary battery may include an unwinding part configured to unwind an electrode sheet on which an electrode active material is applied and dried, a drying part provided behind the unwinding part and configured to receive the electrode sheet from the unwinding part so as to dry the electrode sheet, a slitting part provided behind the drying part and configured to receive the electrode sheet from the drying part so as to cut the electrode sheet, thereby forming a plurality of unit electrode sheets, and a rewinding part provided behind the slitting part and configured to receive the plurality of unit electrode sheets from the slitting part so as to wind the plurality of unit electrode sheets. Additionally, another example of the present invention includes a method for manufacturing a secondary battery.

### TECHNICAL FIELD

### Cross-Reference to Related Application

The present application claims the benefit of the priority of Korean Patent Application No. 10-2022-0019794, filed on Feb. 15, 2022, which is hereby incorporated by reference in its entirety.

### TECHNICAL FIELD

The present invention relates to an apparatus for manufacturing a secondary battery and a method for manufacturing a secondary battery using the same, and more particularly, to an apparatus for manufacturing a secondary battery, which slits an electrode, and a method for manufacturing the secondary battery using the same.

### BACKGROUND ART

In general, secondary batteries refer to chargeable and dischargeable batteries, unlike primary batteries that are not chargeable. The secondary batteries are being widely used in the high-tech electronic fields such as mobile phones, notebook computers, and camcorders.

Such a secondary battery comprises an electrode assembly in which electrodes and separators are alternately stacked and a case accommodating the electrode assembly, and the electrode assembly has a structure in which the plurality of electrodes and the plurality of separators are alternately stacked.

Also, a method for manufacturing the secondary battery comprises an electrode manufacturing process of manufacturing electrodes, an electrode assembly assembling process of stacking the manufactured electrodes and a separator to assemble an electrode assembly, and a process of accommodating the manufactured electrode assembly in a case to manufacture the secondary battery.

Here, the electrode manufacturing process generally includes a coating process of applying and drying an electrode active material on an electrode sheet, a press process of pressing the electrodes after the coating process, and a slitting process of cutting each of the electrodes into a preset width after the press process.

However, in the related art, after the slitting process and before the electrode assembly assembling process, a drying process of drying unit electrodes formed in the slitting process has to be additionally performed. Since the divided unit electrodes are collected so that a worker puts each of the unit electrodes into a vacuum drying facility in the drying process, the processes are discontinuous and take a lot of time, and thus, there is a problem in that the electrode manufacturing process is deteriorated in productivity. Thus, it is necessary to develop a technology to solve the above problem.

### DISCLOSURE OF THE INVENTION

### Technical Problem

The present invention has been made to solve the above problem, and an object of the present invention is to provide an apparatus for manufacturing a secondary battery, in which a drying device is introduced into a device for slitting an electrode to perform both electrode drying and slitting in one facility to significantly improve electrode productivity, and a method for manufacturing a secondary battery using the same.

### Technical Solution

The present invention in one example may provide an apparatus for manufacturing a secondary battery, which may include an unwinding part configured to unwind an electrode sheet on which an electrode active material is applied and dried, a drying part provided behind the unwinding part and configured to receive the electrode sheet from the unwinding part so as to dry the electrode sheet, a slitting part provided behind the drying part and configured to receive the electrode sheet from the drying part so as to cut the electrode sheet, thereby forming a plurality of unit electrode sheets, and a rewinding part provided behind the slitting part and configured to receive the plurality of unit electrode sheets from the slitting part so as to wind the plurality of unit electrode sheets.

The unwinding part may include at least one unwinding roller configured to unwind the electrode sheet, the rewinding part may include at least one rewinding roller configured to wind the plurality of unit electrode sheets, and the unwinding roller roller may be configured to rotate in and the rewinding synchronization with each other.

The drying part may include a heating body having a drying space, through which the electrode sheet passes, and a plurality of heating members provided in the drying space configured to directly heat a surface of the electrode sheet so as to dry moisture remaining on the electrode sheet.

The drying part may further include a plurality of rollers provided at different positions in the drying space configured to change a transfer direction of the electrode sheet.

The plurality of heating members may be provided to correspond to both surfaces of the electrode sheet so as to dry both the surfaces of the electrode sheet at a same time.

Each of the heating members of the plurality of heating members may include an infrared lamp.

The drying part may be configured to dry the electrode so that a moisture content of the electrode sheet is equal to or less than approximately 200 ppm.

The slitting part may include a main body provided in a pair, the pair being configured to include the electrode sheet therebetween, and at least one cutter fixed and installed on the main body which is configured to cut the electrode sheet in a transfer direction of the electrode sheet.

Each of the unit electrode sheets of the plurality of unit electrode sheets may have a width less than approximately 700 mm.

In addition, the present invention in one example may provide a method for manufacturing a secondary battery, which includes an unwinding process of unwinding an electrode sheet on which an electrode active material is applied and dried, a drying process of drying the electrode sheet after the unwinding process, a slitting process of cutting the dried electrode sheet to form a plurality of unit electrode sheets after the drying process, and a rewinding process of winding plurality of the unit electrode sheets after the slitting process, wherein the unwinding process, the drying process, the slitting process, and the rewinding process are continuously performed.

### Advantageous Effects

Since the apparatus for manufacturing the secondary battery according to the present invention includes the drying part and the slitting part to perform the slitting and drying of the electrode in one device, the processes may be integrated to remove the redundant device, thereby simplify the facility. Therefore, there may be the advantage of reducing the facility space and reducing the investment costs during the mass production.

In addition, in the apparatus for manufacturing the secondary battery according to the present invention, since the slitting and drying of the electrode are continuously performed in one device, there may be the advantages of reducing the time taken to manufacture the electrode and improving the electrode yield to significantly improve the productivity.

In addition, since the drying part of the present invention includes the heating member that directly heats the surface of the electrode sheet, the moisture remaining in the electrode may be quickly dried, the work time may be greatly reduced to improve the productivity.

### BRIEF DESCRIPTION OF THE DRAWINGS

FIG. 1 is a conceptual view illustrating an apparatus for manufacturing a secondary battery according to a first embodiment of the present invention.

FIG. 2 is a detailed view illustrating a configuration of a drying part in the apparatus for manufacturing the secondary battery of FIG. 1.

FIG. 3 is a detailed conceptual view illustrating a process of forming a unit electrode sheet by cutting an electrode sheet through a slitting part in the apparatus for manufacturing the secondary battery of FIG. 1.

FIG. 4 is a flowchart illustrating processes in a method for manufacturing a secondary battery according to a second embodiment of the present invention.

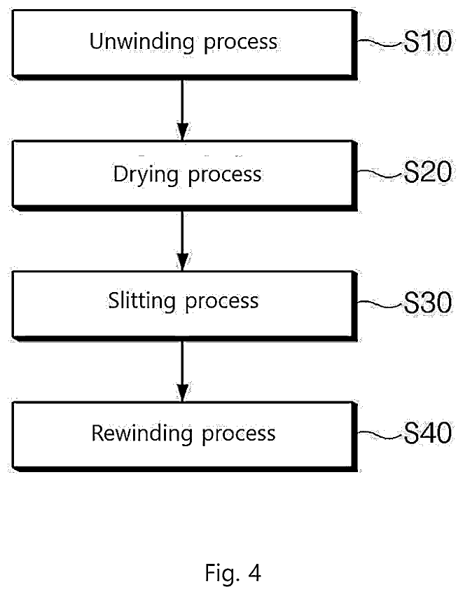

### MODE FOR CARRYING OUT THE INVENTION

Hereinafter, embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain the present invention, detailed descriptions of portions that are irrelevant to the description or related known technologies that may unnecessarily obscure the gist of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

### Apparatus for Manufacturing Secondary Battery

The present invention provides an apparatus for manufacturing a secondary battery, which includes: an unwinding part 100 that unwinds an electrode sheet 1, on which an electrode active material is applied and dried; a drying part 200 provided behind the unwinding part 100 to receive the electrode sheet 1 from the unwinding part 100 so as to dry the electrode sheet 1; a slitting part 300 provided behind the drying part 200 to receive the electrode sheet 1 from the drying part 200 and cut the electrode sheet 1, thereby forming a plurality of unit electrode sheets 1′; and a rewinding part 400 provided behind the slitting part 300 to receive the unit electrode sheets 1′ from the slitting part 300 so as to wind the unit electrode sheets 1′.

First, the unwinding part 100 may be configured to unwind the electrode sheet 1 on which the electrode active material is applied and dried and may have various configurations. Here, the electrode sheet 1 on which the electrode active material is applied and dried may be understood as a coated electrode sheet, on which a coating process is completed, in the art.

Specifically, the unwinding part 100 may include at least one unwinding roller 120 that unwinds the electrode sheet 1 and a main body 110 that rotatably supports the unwinding roller 120.

Here, the unwinding roller 120 may unwind the electrode sheet 1, which is wound in a roll shape and on which the electrode active material is applied and dried, through rotation to the electrode sheet 1 to the drying part 200 to be described later.

Here, the unwinding roller 120 may rotate at the same speed in synchronization with the rewinding roller 420 to be described later, and thus, the electrode sheet 1 and the unit electrode sheet 1′ may be continuously transferred on the apparatus for manufacturing the secondary battery to improve process productivity.

The electrode sheet 1 unwound from the unwinding part 100 may be transferred to the drying part 200 provided behind the unwinding part 100.

Here, the drying part 200 may be provided behind the unwinding part 100 and be configured to receive the electrode sheet 1 from the unwinding part 100 so as to dry the electrode sheet 1 and also may have various configurations.

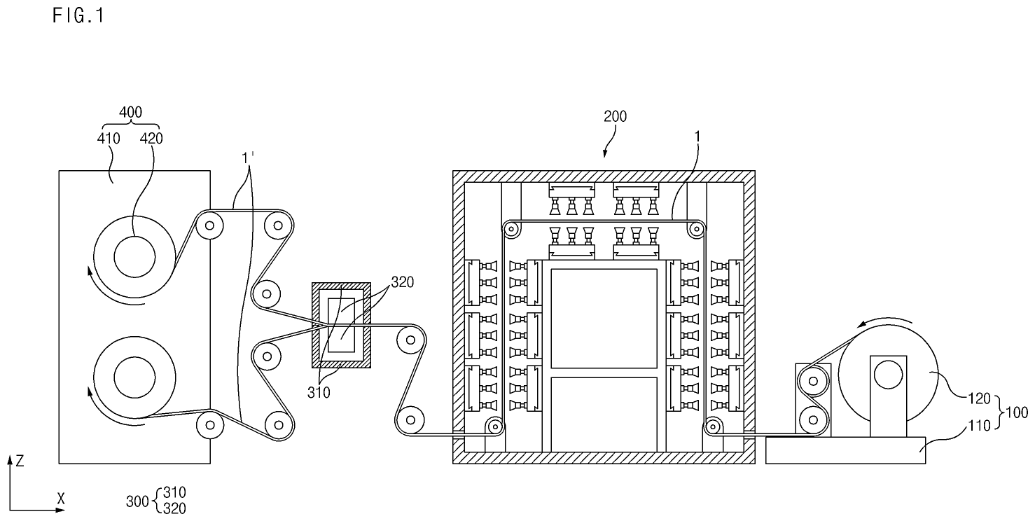

Specifically, as illustrated in FIG. 1, the drying part 200 may be provided between the unwinding part 100 and the slitting part 300 to be described later to dry the electrode sheet 1 until the electrode sheet 1 is unwound from the unwinding part 100 and then supplied to the slitting part 300.

That is, in a process of transferring the electrode sheet 1 from the unwinding part 100 to the slitting part 300 to be described later, the drying part 200 may dry the electrode sheet 1 while transferring the electrode sheet 1 to minimize a time taken to dry the electrode sheet 1.

Here, it may be that the drying part 200 sufficiently dries the electrode sheet 1 supplied from the unwinding part 100 to omit a sequent additional drying process. For example, the drying part 200 may dry the electrode sheet 1 so that a moisture content of the electrode sheet 1 is equal to or less than 200 ppm until the electrode sheet 1 is supplied to the slitting part 300.

The drying part 200 may include: a heating body 210 having a drying space S through which the electrode sheet 1 passes; and a plurality of heating members 220 provided in the drying space S to directly heat a surface of the electrode sheet 1, thereby drying the moisture remaining in the electrode sheet 1.

Here, the heating body 210 may be configured to define the drying space S through which the electrode sheet 1 passes and may have various configurations.

For example, the heating body 210 may have a rectangular box shape in which the drying space is defined therein and be provided with an entrance, through which the electrode sheet 1 passes, in at least one surface thereof. The heating body 210 having such a structure may introduce the electrode sheet 1 into the drying space S through an inlet and may discharge the electrode sheet 1 introduced into the drying space S through an outlet.

The heating member 220 may be provided in the drying space S to directly heat the surface of the electrode sheet 1, thereby drying the moisture remaining in the electrode sheet 1 and may have various configurations.

Here, the heating member 220 may have any configuration as long as the heating member 200 directly heats the surface of the electrode sheet 1. For example, the heating member 220 may include an infrared lamp to directly heat the surface of the electrode sheet 1. In this case, there is an advantage of effectively drying the electrode sheet 1 even if a vacuum state is not defined around the electrode sheet 1.

The heating member 220 may heat the surface of the electrode sheet 1 at a preset temperature to dry the electrode sheet 1. Here, the preset temperature may be variously set by a user and may be set, for example, between 160 degrees and 180 degrees.

The drying part 200 may further include a support 240 that fixes and supports the heating member 220 so that the heating member 220 is fixedly installed in the drying space S. Here, the support 240 may have various configurations.

For example, the support 240 may include a fixing part 241 fixed inside the heating body 210 or to an auxiliary support 250 to be described later and a detachable part 242 which is detachably coupled to the fixing part 241 and in which at least one heating member 220 is installed.

In this case, when replacing the plurality of heating members 220, the detachable part 242 may be detached from the fixing part 241, and then, the heating member 220 may be replaced. Then, when the replacement is completed, the detachable part 242 may be coupled again to the fixing part 241. Therefore, the heating member 220 may be easily maintained.

The above-described heating member 220 may be provided to correspond to both surfaces of the electrode sheet 1 so as to quickly and effectively dry the electrode sheet 1, thereby drying both the surfaces of the electrode sheet 1 at the same time.

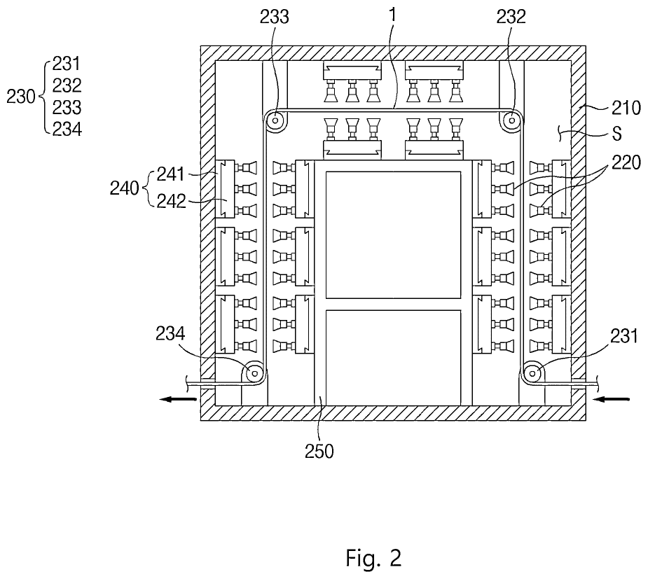

In this case, as illustrated in FIG. 2, the heating member 220 that dries one surface of the electrode sheet 1 facing an inner wall of the heating body 210 may be installed along the inner wall of the heating body 210. The heating member 220 that dries the other surface of the electrode sheet 1 may be installed in the auxiliary support 250 provided at a central portion of the drying space S. Here, the auxiliary support 250 may be configured to fix the heating member 220 and/or the support 240 supporting the heating member 220 and may have various configurations.

The drying part 200 may further include a plurality of rollers 230 provided at different positions in the drying space S to change a transfer direction of the electrode sheet 1 on the drying space S. In this case, a length and stay time of the electrode sheet 1 introduced into the drying space S may increase, and a drying time through the heating member 220 may naturally increase to improve drying efficiency of the electrode sheet 1.

For example, the plurality of rollers 230 may include a first roller 231 provided in one region of the drying space S, a second roller 232 provided above the first roller 231, a third roller 233 provided at one side of the second roller 232, and a fourth roller 234 provided below the third roller 233.

More specifically, as illustrated in FIG. 2, the plurality of rollers 230 may be provided at lower right, upper right, upper left, and lower left sides of the drying space S, respectively. In this case, the electrode sheet 1 introduced into the drying space S may be sequentially transferred along right, top, and left surfaces of the inner wall of the heating body, as illustrated in FIG. 2.

The electrode sheet 1 dried by the drying part 200 may be cut by the slitting part 300 to form the plurality of unit electrode sheets 1′.

Specifically, the slitting part 300 may be provided behind the drying part 200 and be configured to receive the electrode sheet 1 from the drying part 200 and cut the electrode sheet 1, thereby forming the plurality of unit electrode sheets 1′ and also may have various configurations.

For example, the slitting part 300 may include: a main body 310 provided in a pair with the electrode sheet 1 therebetween; and at least one cutter 320 fixed and installed on the main body 310 to cut the electrode sheet 1 in the transfer direction of the electrode sheet 1.

Here, the main body 310 is provided in a pair with the electrode sheet 1 therebetween and may have various configurations. Specifically, the main body 310 may be provided in a pair at the upper and lower sides of the electrode sheet 1 with the electrode sheet 1 therebetween to fix and support at least one or more cutters 320 that cut the electrode sheet 1.

In addition, the cutter 320 may be fixed to the main body 310 and be configured to cut the electrode sheet 1 along the transfer direction of the electrode sheet 1 and also may have various configurations.

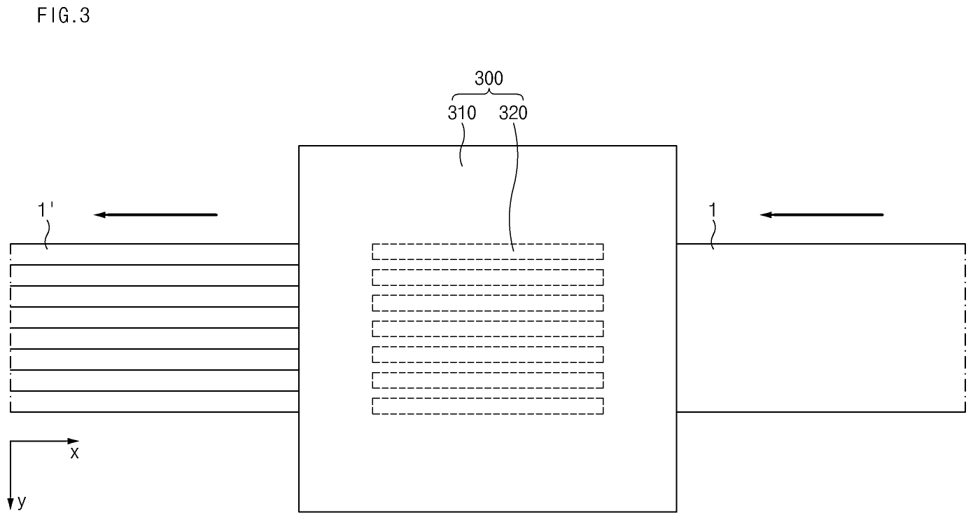

Specifically, as illustrated in FIG. 3, the cutter 320 may cut the electrode sheet 1 in a direction parallel to the transport direction (an X direction in FIG. 3) of the electrode sheet 1. Here, the number of cutters 320 and an interval between the plurality of cutters 320 may vary according to a width of the unit electrode sheet 1′, which is desired by the user.

Here, the width of the unit electrode sheet 1′ may be set in various manners. For example, the width of the unit electrode sheet 1′ may be less than 700 mm. More specifically, the unit electrode sheet 1′ may have a width less than 87.5 mm.

The unit electrode sheet 1′ formed by the slitting part 300 may be wound by the rewinding part 400.

Here, the rewinding part 400 may be provided behind the slitting part 300 and be configured to receive the unit electrode sheet 1′ from the slitting part 300 so as to wind the unit electrode sheet 1′ and also may have various configurations.

Specifically, the rewinding part 400 may include at least one rewinding roller 420 that winds the unit electrode sheet 1′ and a main body 410 that rotatably supports the rewinding roller 420.

Here, the rewinding roller 420 may be configured to wind the unit electrode sheet 1′ by rotation so that the unit electrode sheet 1′ is wound in a roll form and may rotate at the same speed in synchronization with the above-described unwinding roller 120.

As a result, after the drying and slitting processes are completely performed on the electrode sheet 1 unwound from the above-described unwinding roller 120, a process of winding the electrode sheet 1 to from the unit electrode sheet 1′ may be continuously performed to improve process productivity.

Here, a speed at which the electrode sheet 1 and the unit electrode sheet 1′ are transferred in the apparatus for manufacturing the secondary battery may be 105 mm/min to 115 mm/min, for example, 110 mm/min.

### Method for Manufacturing Secondary Battery

The present invention may provide a method for manufacturing a secondary battery, which includes: an unwinding process (S10) of unwinding an electrode sheet 1 to which an electrode active material is applied and dried; a drying process (S20) of drying the electrode sheet 1 after the unwinding process (S10); a slitting process (S30) of cutting the dried electrode sheet 1 to form a plurality of unit electrode sheets 1′ after the drying process (S20); and a rewinding process (S40) of winding the unit electrode sheets 1′ after the slitting process (S30).

Here, the method for manufacturing the secondary battery according to the present invention may be performed in a roll-to-roll process, and thus, the unwinding process (S10), the drying process (S20), the slitting process, and the rewinding process (S40) may be performed continuously. Here, the roll-to-roll process may be understood as a process in which each process is performed while the bendable electrode sheet 1 moves between the rollers.

First, the unwinding process (S10) may be a process of unwinding the electrode sheet 1, to which the electrode active material is applied and dried, and may be performed in various manners. Here, the electrode sheet 1 on which the electrode active material is applied and dried may be understood as a coated electrode sheet, on which a coating process is completed, in the art.

In addition, the unwinding process (S10) may be performed by unwinding the electrode sheet 1 by an unwinding part 100, and here, a detailed description of the unwinding part 100 will be replaced with the above-described contents.

After performing the unwinding process (S10), the drying process (S20) of drying the electrode sheet 1 may be performed.

Here, the drying process (S20) may be a process of drying the electrode sheet 1 after the unwinding process (S10) and may be performed in various manners.

Specifically, in the drying process (S20), the electrode sheet 1 may be sufficiently dried so that there is no need to perform an additional drying process after the drying process. For example, in the drying process (S20), the electrode sheet 1 may be dried so that a moisture content of the electrode sheet 1 is equal to or less than 200 ppm.

The drying process (S20) may be performed by drying the electrode sheet 1 by the drying part 200, and more specific contents about the drying part 200 may be replaced with the above-described contents.

After the drying process (S20) is performed, the slitting process of cutting the electrode sheet 1 may be performed.

Here, the slitting process (S30) may be a process of cutting the dried electrode sheet 1 to form the plurality of unit electrode sheets 1′ after the drying process (S20) and may be performed in various manners.

Specifically, in the slitting process (S30), the electrode sheet 1 may be cut in a direction parallel to a transfer direction (an X direction in FIG. 3) of the electrode sheet 1. Here, the width of the unit electrode sheet 1′ may be set in various manners. For example, the width of the unit electrode sheet 1′ may be less than 700 mm. More specifically, the width of the unit electrode sheet 1′ may be less than 87.5 mm.

In the slitting process (S30), the electrode sheet 1 may be cut by the slitting part 300, and more specific contents about the slitting part 300 may be replaced with the above description.

After the slitting process (S30) is performed, the rewinding process (S40) of winding the unit electrode sheet 1′ may be performed.

Here, the rewinding process (S40) may be a process of winding the unit electrode sheet 1′ after the slitting process (S30) and may be performed in various manners.

Specifically, the rewinding process (S40) may be performed by winding the unit electrode sheet 1′ by the rewinding part 400, and here, detailed descriptions of the rewinding part 400 will be replaced with the above descriptions.

While the embodiments of the present invention have been described with reference to the specific embodiments, it will be apparent to those skilled in the art that various changes and modifications may be made without departing from the spirit and scope of the invention as defined in the following claims.

### DESCRIPTION OF THE SYMBOLS

100: Unwinding part
110: Main body
120: Unwinding roller
200: Drying part
210: Heating body
220: Heating body
230: Roller
231: First roller
232: Second roller
233: Third roller
234: Fourth roller
240: Support
241: Fixing part
242: Detachable part
250: Auxiliary support
300: Slitting part
310: Main body
320: Cutter
400: Rewinding part
410: Main body
420: Rewinding roller
S10: Unwinding process
S20: Drying process
S30: Slitting process
S40: Rewinding process
S: Drying space

1. An apparatus for manufacturing a secondary battery, the apparatus comprising:
an unwinding part configured to unwind an electrode sheet on which an electrode active material is applied and dried;
a drying part provided behind the unwinding part and configured to receive the electrode sheet from the unwinding part so as to dry the electrode sheet;
a slitting part provided behind the drying part and configured to receive the electrode sheet from the drying part so as to cut the electrode sheet, thereby forming a plurality of unit electrode sheets; and
a rewinding part provided behind the slitting part and configured to receive the plurality of unit electrode sheets from the slitting part so as to wind the plurality of unit electrode sheets.

2. The apparatus of claim 1, wherein the unwinding part comprises at least one unwinding roller configured to unwind the electrode sheet,
wherein the rewinding part comprises at least one rewinding roller configured to wind the plurality of unit electrode sheets, and
wherein the unwinding roller and the rewinding roller are configured to rotate in synchronization with each other.

3. The apparatus of claim 1, wherein the drying part comprises:
a heating body having a drying space, through which the electrode sheet passes; and
a plurality of heating members provided in the drying space configured to directly heat a surface of the electrode sheet so as to dry moisture remaining on the electrode sheet.

4. The apparatus of claim 3, wherein the drying part further comprises a plurality of rollers provided at different positions in the drying space configured to change a transfer direction of the electrode sheet.

5. The apparatus of claim 3, wherein the plurality of heating members are provided to correspond to both surfaces of the electrode sheet so as to dry both the surfaces of the electrode sheet at a same time.

6. The apparatus of claim 3, wherein each of the plurality of heating members comprises an infrared lamp.

7. The apparatus of claim 1, wherein the drying part is configured to dry the electrode sheet so that a moisture content of the electrode sheet is equal to or less than approximately 200 ppm.

8. The apparatus of claim 1, wherein the slitting part comprises:
a main body provided in a pair, the pair being configured to include the electrode sheet therebetween; and
at least one cutter fixed and installed on the main body to cut the electrode sheet in a transfer direction of the electrode sheet.

9. The apparatus of claim 1, wherein each of the plurality of unit electrode sheets has a width less than approximately 700 mm.

10. A method for manufacturing a secondary battery, the method comprising:
an unwinding process of unwinding an electrode sheet on which an electrode active material is applied and dried;
a drying process of drying the electrode sheet after the unwinding process;
a slitting process of cutting the dried electrode sheet to form a plurality of unit electrode sheets after the drying process; and
a rewinding process of winding the plurality of unit electrode sheets after the slitting process,
wherein the unwinding process, the drying process, the slitting process, and the rewinding process are continuously performed.
